(19) United States
(12) Patent Application Publication
(10) Pub. No.: US 2014/0379444 A1
(43) Pub. Date: Dec. 25, 2014

(54) Method and Apparatus for Targeted Advertisement Selection and Delivery

(71) Applicants: Scott Frankel, Los Angeles, CA (US); Greg Lam, Los Angeles, CA (US)

(72) Inventors: Scott Frankel, Los Angeles, CA (US); Greg Lam, Los Angeles, CA (US)

(21) Appl. No.: 14/313,076

(22) Filed: Jun. 24, 2014

Related U.S. Application Data
(60) Provisional application No. 61/838,444, filed on Jun. 24, 2013.

(51) Int. Cl. G06Q 30/02

(52) U.S. Cl. CPC G06Q 30/0263
USPC 705/14.6

(57) ABSTRACT

A system includes one or more processors configured to receive content, including a product-designation association, for display on a website. The processor(s) are further configured to send a request to an advertisement-providing computer for one or more advertisements relating to the product-designation. Also, the processor(s) are configured to receive the requested one or more advertisements and designate the received one or more advertisements for display in one or more available advertisement slots on the website.

### CROSS-REFERENCE TO RELATED APPLICATIONS

This application claims the benefit of U.S. provisional application Ser. No. 61/838,444 filed Jun. 24, 2013, the disclosure of which is hereby incorporated in its entirety by reference herein.

### TECHNICAL FIELD

The illustrative embodiments generally relate to a method and apparatus for targeted advertisement selection and delivery.

### BACKGROUND

A major push in online advertising is to deliver content that is relevant to a particular consumer. Originally, when online advertising began, static banner ads and pre/post-roll clips were selected for websites that may have, for example, matched a theme of that website or online video. For example, Vogue online may have had advertisements for fashion retailers, and Guns and Ammo online may have had advertisements for hunting and fishing retailers.

Similarly, when various pages or videos were accessed by users, different advertisements would be displayed or popped up. Sometimes these pop ups were thematically related to the content provider's general message, and sometimes they appeared to be completely random. Advertisements displayed in conjunction with “non-content” producing sources (e.g., search engine search screens) also generally were somewhat random.

Modifications to these systems have begun to track user behavior and provide content that is relevant to previously viewed content or to searches that a user is performing/has performed. For example, a search on Amazon.com for a particular item may cause an advertisement for that item to be displayed when a completely different website or video is accessed. In another model, a search on Google.com may produce advertisements along with the search results that relate to the subject matter searched.

In this and other manners, advertisers can begin to tailor advertisements to better target the needs of a viewing consumer, thus increasing the likelihood of successfully engaging the consumer to interact with the advertisement and maybe to buy a product.

### SUMMARY

In a first illustrative embodiment, a system includes one or more processors configured to receive content, including a product-designation association, for display on a website. The processor(s) are further configured to send a request to an advertisement-providing computer for one or more advertisements relating to the product-designation. Also, the processor(s) are configured to receive the requested one or more advertisements and designate the received one or more advertisements for display in one or more available advertisement slots on the website.

In a second illustrative embodiment, a system includes one or more processors configured to retrieve one or more advertisements from an advertisement database, wherein the one or more advertisements relate to pre-designated criteria associated with content to be displayed on a website. The processor(s) are further configured to determine if sufficient advertisement slots are available in conjunction with display of the content to support display of all retrieved advertisements. Also, the processor(s) are configured to rank the retrieved advertisements according to predefined criteria, conditional on insufficient advertisement slot availability. The processors are additionally configured to designate retrieved advertisements for display in available advertisement slots associated with the content, wherein if the retrieved advertisements are ranked, the retrieved advertisements are designated for display in order of ranking, until no available advertisement slots remain.

In a third illustrative embodiment, a computer-implemented method includes receiving content, including a product-designation association, for display on a website. The method further includes sending a request to an advertisement-providing computer for one or more advertisements relating to the product-designation. The method also includes receiving the requested one or more advertisements and determining, via a computer, which received one or more advertisements will be displayed in which one or more available advertisement slots on the website.

### BRIEF DESCRIPTION OF THE DRAWINGS

FIG. 1 shows an illustrative example of a request for advertisements;

FIG. 2 shows an illustrative example of advertisement retrieval;

FIG. 3 shows an illustrative example of advertisement selection and price setting; and

FIG. 4 shows an illustrative example of multiple advertisement display for single content.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Editors and authors of online content create thousands of articles and videos each week. With the scope of online publishing, the contents of these posts are almost limitless, and while it is somewhat easier to generally gauge a reader demographic, it can still be difficult to deliver advertising content that is most likely to be used by a particular reader. For example, an online fashion magazine may generally post advertisements similar to those found on its paper pages, but it is difficult to know if there is any degree of success associated with delivery of a particular advertisement for a given reader (e.g., a man reading an article about jeans may not be interested in a perfume advertisement).

Through the illustrative embodiments, it will be made possible to more specifically target advertisements to the readers of a given article or video clip. While the particular demographics of a certain reader may not be known (due to the general anonymity of the internet), data embedded within the article or video itself can be used to gather and deliver advertisements that are relevant to the content of the article or clip. In this way, the advertisers and content providers know that there is at least a measure of relevance to the consumer, since it is unlikely that a consumer is reading an article or watching a video, in which they have no interest.

One method of providing such capability includes the content producer, through a manual or automated process, creating associations within an article/video clip. This hidden, meta-data can be used to determine advertisements that are particularly relevant to the contents, and thus, presumably, to the reader/watcher. In another example, similar data can be obtained by parsing the content and focusing on key-words or commonly occurring words or phrases.

In the model that uses content-creator selected data, which will be the example used with the illustrative embodiments, the content-creator has some measure of control over what particular data will be used for focusing advertisements. For example, in an article on fashion that covers both jeans and shoes, the content creator can elect to focus advertisements on jeans, shoes, or both (or, for that matter, any other content or related ideas). In one example, the content creator will select content in the article that has purchasable characteristics (e.g., manufacturer and retailer). The affiliation will then have these characteristics associated therewith, in this model noted by the content creator.

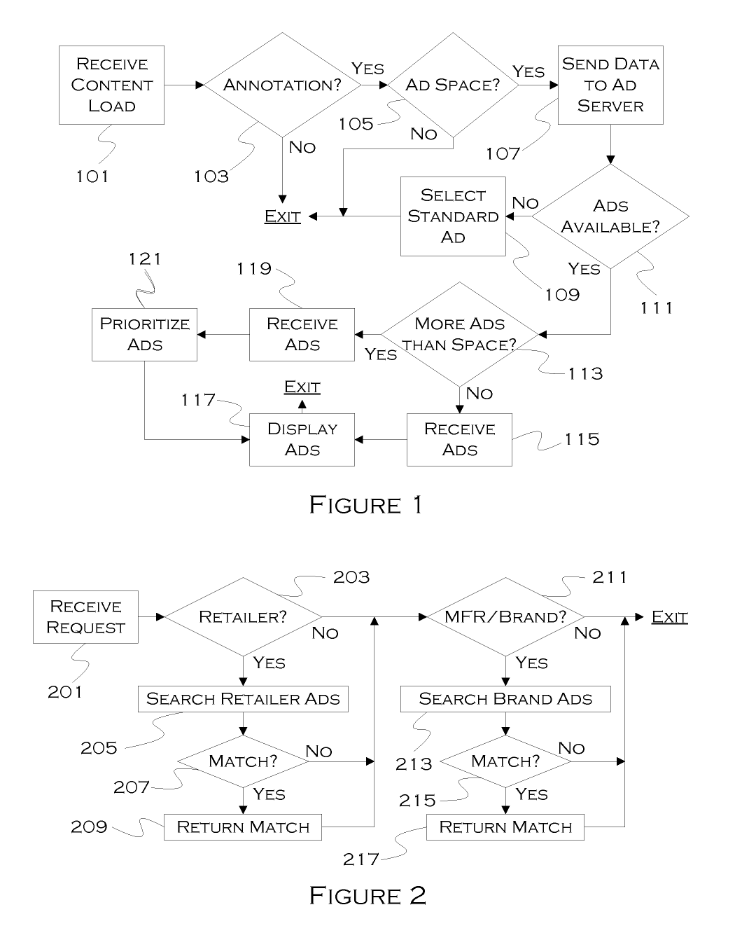

FIG. 1 shows an illustrative example of a request for advertisements. In this illustrative example, a process runs on the content provider's website that will be responsible for selecting advertisements associated with annotated content. The process can be a plug-in associated with the website or any other suitable process that can run in conjunction with content for advertisement selection. In at least one embodiment, the process can run in the background or off-line and pre-select advertisements for a day, week, indefinitely or some other time-block.

With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process receives a set of content to be examined, which may have annotations associated therewith 101. Presumably, for example, this is content that would be displayed or is being displayed on a content provider's website. In addition, there are possibly one or more advertisement slots that are available for use in conjunction with the content.

In this example, if there are annotations in the content 103, the process can engage in advertisement selection. As previously mentioned, if the content was to be parsed for key-words/phrases, the process may move to such a parsing if no annotated content were present. In this example, the process merely exits.

Also, if there are no advertisement slots available 105 the process will exit. For example, the process may recognize several content annotations but the website may have already filled the available advertisement slots, or, for example, the content may run in both a free and premium format, and in the premium format the same content may not have advertisements associated therewith.

If there are both annotations and advertisement space available, the process may send the data to an advertisement server 107. The data sent can include, but is not limited to, ad spaces available, annotation information (e.g., manufacturer, brand, retailer, type of product, etc.). Pricing for various advertisement slots, time windows, placements, etc. could also be sent for use in ad selection.

If one or more ads are available 111, the process will check if there are more ads than space available. For example, if the annotation related to Levi's Jeans, the process may receive three ads for Levis and seven ads for various Levi's retailers, but only have two total slots available for displaying advertisements. If there are exactly as many ads as slots, the process will receive the advertisements 115 and display the ads in the corresponding slots 117. Pricing may vary per slot, as the content provider sees fit.

If there are extra ads available, the process may receive the ads 119 and engage in a prioritization process 121. This process can be done in a number of manners. First in/first out is one prioritization option, as is ranking ads based on how much a content provider is willing to pay to have an ad displayed. Ads can also be ranked by particular relevance, e.g., in the above example, a Macy's as for Levi's jeans fits both the manufacturer and the retailer constraints, whereas a Macy's ad for something else or a Levi's ad for jackets only fits one constraint. Any suitable and workable paradigm for advertising ranking/ordering may be utilized as appropriate.

If there are no ads available at step 111, the process can revert to using a standard ad selection process for the website 109.

FIG. 2 shows an illustrative example of advertisement retrieval. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process is on the advertisement server side and works in conjunction with the process shown in FIG. 1. Here, the server side process receives a request for one or more advertisements 201. In this example, the annotations relate to retailer and brand/manufacturers of products, so the process first checks to see if a given annotation has a retailer associated therewith 203.

If there is a retailer association, the process will search a retailer database for possibly relevant advertisements 205. The relevance criteria can be set by the requesting site and/or the advertisement provider. Some sites may want any ad by Macys for the Levi jeans example, other sites may want ads by Macys for jeans, and others still may only want ads by Macys for Levi jeans.

If there is a match for a retailer that may or may not meet other set forth criteria as defined by the requestor or provider 207, the process will return the match(es) 209 to the requesting site and move to a manufacturer selection process 211. If there are not matches, or if there was no designation of a retailer provided, the process may also move to the manufacturer selection 211.

If there is a designation of a manufacturer or brand 211, the process may perform a similar search for advertisements based on the manufacturer or brand 213. Again, if desired, criteria established by the requesting party or the providing party can also be used to tailor down the search and selection process. If there are one or more matches 215, the process will return the matching advertisements.

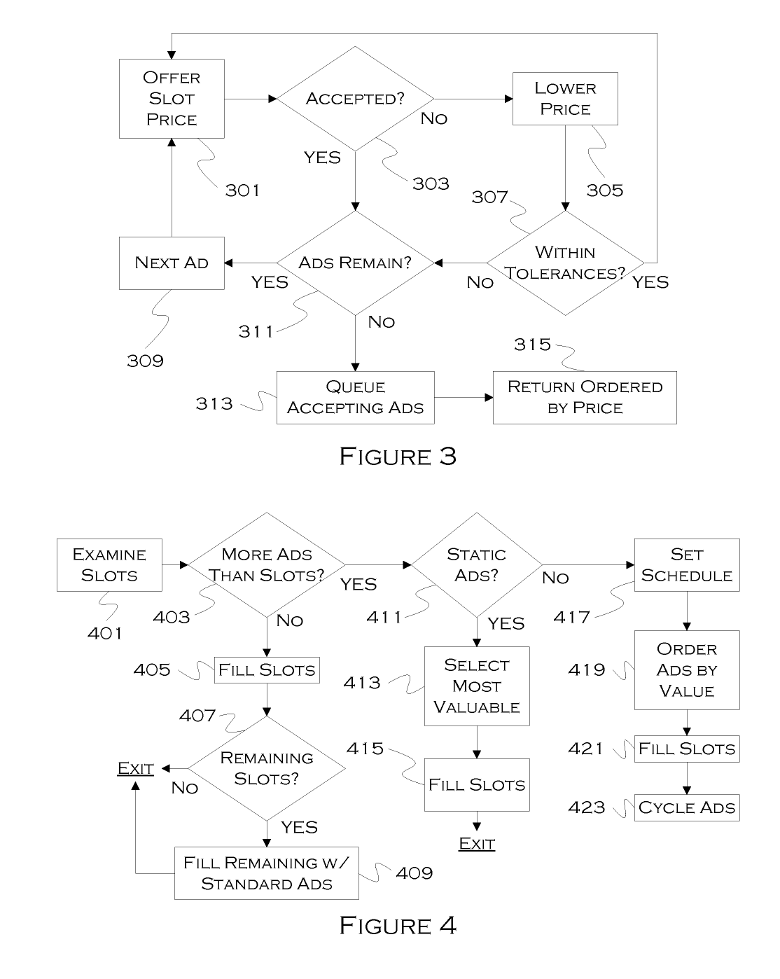

FIG. 3 shows an illustrative example of advertisement selection and price setting. In this illustrative example, pricing for advertisements may be varied based on what advertisers are willing to pay for use of a given slot. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

While much more complicated schemas can be envisioned, this exemplary scenario shows one non-limiting manner of matching pricing with advertisements in order to utilize all slots with the most relevant ads possible, whose providers are also willing to pay a requested price for an advertisement slot.

In this illustrative example, the process offers a price for a given advertisement slot on a given page 301. In at least one model, other information (such as publisher/provider of content or location of advertisement may be available), but in this simple, non-limiting example the decision is based on price for simplicities sake. If the advertisement “accepts” the price 303, the process can check to see if additional advertisements remain.

In this illustrative model, advertisement slots may have a price range associated therewith. For example, the price range may be $0.25-$0.50. Also, in this model, there may be four advertisements, each of which has a price cap associated therewith, which represents a maximum an advertiser is willing to pay. Advertisement A may have a cap of $0.60. Advertisement B may have a cap of $0.75, advertisement C a cap of $0.40 and advertisement D a cap of $0.20.

To maximize publisher/provider profit, in this model, the price offering would start at the $0.50 cent mark. This price would be offered to Ad A, which would be accepted because it is below the cap. Since ads B, C and D remain 311, the process would then move to Ad B 309, which would also accept the price. The process would then attempt the same offering for Ad C.

Since Ad C has a cap of $0.40, the $0.50 price would be refused. In this model, the price would then be lowered 305 and the process would check to see that the lower price was still within the acceptable range 307 associated with the advertisement space. If the price went down in $0.01 cent increments, after ten loops the price would arrive at $0.40 cents, which would fit the price range of Ad C and be accepted. The process would then move to Ad D.

For Ad D, the process would again start at $0.50 cents, but since D is only willing to pay $0.20, no agreement could be reached. In this case, since the price would drop to $0.24 at one point as an agreement price was sought, the process would recognize that the new price is below the acceptable range and not offer the $0.24 pricing (or any price below that). Since no ads now remain, the process would queue the accepting ads 313 and return a list of advertisements ordered by price.

In the case where at least two advertisement slots are available, advertisement A and B would both be displayed and both advertiser creators would be satisfied. But, from the example, it is clear that the provider of Ad B is willing to pay more than that of Ad A. If there were only one slot available, depending on the model used by the content creator, Ad A may be selected since that was the first ad to accept the original offered price. In such a case, the process (not shown) may engage in up-bidding the price of the ad for accepting advertisers, so that eventually a price of $0.61 is reached, which is above A's cap, but still within B's. If A and B had the same cap, then A would win out in the above scenario.

If true revenue maximization is desired, the price could continue to rise until B's tolerance cap was met, depending on where the entity doing the pricing desires to dole out savings. In the above model, both the provider of B and the advertising site are happy, because B got a deal and the site got more than expected for the ad. In the model where pricing rose until B's tolerance was met, the site would maximize revenue from B.

Other suitable means of ranking and pricing advertisements can be used, this is just an illustrative example of a possible method, presented to show that pricing can be based on limited space and adjusted as appropriate based on both tolerances of advertisers and the amount of space available. Pricing can also be adjusted to maximize advertising revenue

FIG. 4 shows a second illustrative example of a multiple advertisement display selection process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process may be presented with a scenario where there are more advertisements than slots available, and several illustrative, non-limiting examples of how to handle such a case are presented. These are presented as examples only, and any suitable method of advertisement selection/organization may be used.

In this illustrative example, an advertisement placement process examines the number and type of advertising slots that are available in conjunction with any given content set 401. If there are not more ads than slots 403, then the process can fill the available slots with the returned ads and there is no conflict 405. On the other hand, even in this scenario, certain slots may be more desirable and this or other suitable ranking models can be applied for choosing particular ads for particular slots. If any slots remain after the advertisements have been placed 407, the process uses a standard model or other appropriate model for filling those slots 409.

If there are more ads than slots (e.g., one slot for the three ads A, B and C above, the process has additional decisions to make. In this illustrative example, the process may recognize that the advertisements going into the slots will be static 411, i.e., they will not scroll through multiple advertisements during content display or on different instances of content display.

If the ads are static in nature, the process will, in this example, select a most valuable advertisement 413. The value can be determined by a price paid for the slot, a price for a “click,” a price for a purchase resulting from a click, or by any other suitable manner. The static slot(s) are then filled by the process based on the rankings of ads and the selected ads 415. If the ads are pre-ranked based on some acceptable schema, the process can use the ads in the order they were returned by the ranking process. Or, optionally, the ads can merely be used in a first in first out fashion.

If the ad spaces are not static, i.e., if the ads can shift during content presentation, for example, the process may be able to utilize all ads willing to pay an acceptable price for the slots. A schedule for shifting ads can be set 417. In some models, the schedule may be time-based, for example, every thirty seconds. In other models, the ads may shift as different pages of an article with different content are read. Other suitable scheduling is also possible.

In this example, the process will again rank the ads by value, or may have received the ads ranked by value (or by any other suitable criteria) 419. Each of the available slots is then filled by the appropriate ad 421, and then the ads are cycled as the schedule dictates 423.

For example, if two slots were available for ads A, B and C, and the ads rotated on 30 second intervals, the process could fill slot 1 with B, slot 2 with A and put C in a queue for slot 1. When the 30 seconds passed, slot 1 would shift to C, and slot 2 would shift to B (the highest ranking ad, since the schedule looped). 30 seconds later, slot 1 would have ad A, and slot 2 would have ad C. Then the schedule would repeat until the page was left. Other suitable scheduling paradigms can also be used, this is just one example of how to present the received content associated with the page.

In another model, if page one of an article had information relating to ad A and page two had annotated content relating to ads B and C, then ad A may be shown while page one was being viewed and ad B may be shown while page two was being viewed. Even though B may have paid more for a slot, it might be desirable to have the highest paying ad which associates directly to the content being viewed as the displayed ad.

While the illustrative embodiments have been described in terms of static/text based advertising opportunities, similar principles can be applied to video clips as well. Editors/creators of video clips can include similar advertising opportunities in the meta-data associated with video clips, either usable to pre-select advertisements or select advertisements based on what portions of a clip have been viewed. Just as with the text advertisements, these annotations can be used in conjunction with available add space/time (in a video clip) to determine which advertisements should be presented.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
one or more processors configured to:
receive content, including a product-designation associated therewith, for display on a website;
send a request to an advertisement-providing computer for one or more advertisements relating to the product-designation;
receive the requested one or more advertisements; and
designate the received one or more advertisements for display in one or more available advertisement slots on the website.

2. The system of claim 1, wherein the product-designation includes a product brand.

3. The system of claim 1, wherein the product-designation includes a product type.

4. The system of claim 1, wherein the product-designation includes a product retailer.

5. The system of claim 1, wherein a number of available advertisement slots is included with the request, and a number of received advertisements corresponds to the number of available advertisement slots.

6. The system of claim 1, wherein the product-designation includes data annotated to the content prior to receipt of the content.

7. A system comprising:
one or more processors configured to:
retrieve one or more advertisements from an advertisement database, wherein the one or more advertisements relate to pre-designated criteria associated with content to be displayed on a website;
determine if sufficient advertisement slots are available in conjunction with display of the content to support display of all retrieved advertisements;
conditional on insufficient advertisement slot availability, rank the retrieved advertisements according to predefined criteria; and
designate retrieved advertisements for display in available advertisement slots associated with the content, wherein if the retrieved advertisements are ranked, the retrieved advertisements are designated for display in order of ranking, until no available advertisement slots remain.

8. The system of claim 7, wherein the ranking is based at least in part on a price an advertiser is willing to pay, associated with an advertisement.

9. The system of claim 7, wherein a plurality of pre-designated criteria is associated with the content, and wherein the ranking is based on correlation of an advertisement with the pre-designated criteria.

10. The system of claim 9, wherein each of the plurality of pre-designated criteria has a value associated therewith, and wherein the ranking is based on values attributable to advertisements based on which of the pre-designated criteria to which a given advertisement corresponds.

11. The system of claim 9, wherein advertisements corresponding to more of the plurality of pre-designated criteria are assigned a higher ranking than advertisements corresponding to fewer of the plurality of pre-designated criteria.

12. The system of claim 7, wherein the advertisement slots are configured to display successive advertisements, changing after a predefined period of time, and wherein the processor is configured to designate an order for display of advertisements based on the ranking.

13. A computer-implemented method comprising:
receiving content, including a product-designation associated therewith, for display on a website;
sending a request to an advertisement-providing computer for one or more advertisements relating to the product-designation;
receiving the requested one or more advertisements; and
determining, via a computer, which received one or more advertisements will be displayed in which one or more available advertisement slots on the website.

14. The method of claim 13, wherein the product-designation includes a product brand.

15. The method of claim 13, wherein the product-designation includes a product type.

16. The method of claim 13, wherein the product-designation includes a product retailer.

17. The method of claim 13, wherein a number of available advertisement slots is included with the request, and a number of received advertisements corresponds to the number of available advertisement slots.

18. The method of claim 13, wherein a number of received advertisements exceeds a number of available advertisement slots and the determining further includes ranking the advertisements according to predefined criteria prior to designating the received advertisements for display;
and designating advertisements for display in order of ranking, until no advertisement slots remain.

19. The method of claim 18, wherein the ranking is based on a monetary value associated with each advertisement.

20. The method of claim 18, wherein the ranking is based on each advertisement's correlation to one or more of a plurality of product-designation associations, such that advertisements corresponding to more product-designation associations have a higher ranking than advertisements corresponding to fewer product designation associations.
